(19) United States
(12) Patent Application Publication
(10) Pub. No.: US 2023/0160465 A1
(43) Pub. Date: May 25, 2023

(54) Device with a Decoupled Cylinder Sleeve

(71) Applicant: ZF Friedrichshafen AG, Friedrichshafen (DE)

(72) Inventors: Stephan Scharr, Friedrichshafen (DE); Norbert Inerle, Tettnang (DE); Tobias Brenner, Bovenden (DE)

(21) Appl. No.: 17/798,938

(22) PCT Filed: Jan. 18, 2021
(86) PCT No.: PCT/EP2021/050888

§ 371 Date: Aug. 11, 2022

(30) Foreign Application Priority Data
Feb. 12, 2020 (DE) 10 2020 201 749.2

(51) Int. Cl. F16H 57/023; F16H 1/28; F16H 57/08; H02K 7/10

(52) U.S. Cl. CPC F16H 57/023; F16H 1/28; F16H 57/08; H02K 7/10

(57) ABSTRACT

A device includes a cylinder sleeve (3, 13), which is at least indirectly arranged at a housing (7) and at least three radially outward extending journals (5). Each journal (5) comes to rest, at least on one side, against a roller element (6a, 6b) accommodated at the housing (7) in order to support the cylinder sleeve (3, 13) on the housing (7) in at least one tangential direction. The device can be designed, in particular, as a planetary transmission or as an electric machine.

### CROSS-REFERENCE TO RELATED APPLICATIONS

The present application is related and claims priority to 102020201749.2 filed in the German Patent Office on Feb. 12, 2020 and is a U.S. national phase of PCT/EP2021/050888 filed in the European Patent Office on Jan. 18, 2021, both of which are incorporated by reference in their entirety for all purposes.

### FIELD OF THE INVENTION

The invention relates generally to a device having a cylinder sleeve, which is at least indirectly supported on a housing. The invention further relates generally to a device designed as a planetary transmission as well as to a device designed as an electric machine.

### BACKGROUND

DE 10 2011 076 521 A1 describes a housing-side fastening arrangement of a ring gear of a planetary gear set having a bearing shield for supporting an output shaft of the planetary gear set for an electric vehicle drive system. Between the bearing shield and a ring gear carrier accommodating the ring gear, a connecting section is provided for transmitting the ring gear torque, wherein the connecting section is configured such that the connecting section has at least a lower radial rigidity with respect to the ring gear carrier.

### SUMMARY OF THE INVENTION

Example aspects of the present invention provide a device, which implements a structurally easily implementable acoustic vibration decoupling.

A device according to example aspects of the invention includes a cylinder sleeve, which is at least indirectly arranged at a housing and includes at least three radially outward extending journals. Each journal comes to rest, at least on one side, against a roller element accommodated at the housing in order to support the cylinder sleeve on the housing in at least one tangential direction. In other words, the cylinder sleeve is axially accommodated at least partially in a stationarily situated housing and is supported, via the journals arranged at the particular roller element, on the housing and, in fact, essentially tangentially. Consequently, a torque acting on the cylinder sleeve is introduced or redirected tangentially into the housing via the journals and the roller elements. The particular journal is displaceable in the radial direction in relation to the housing and, in the process, can roll on the particular roller element.

Preferably, each journal is arranged between two roller elements accommodated at the housing. This means, two roller elements in each case are arranged in one recess on an internal-shell wall surface of the housing and, between themselves, accommodate one of the journals fixedly connected to the cylinder sleeve. The roller elements are preferably designed as cylindrical pivots, rollers, or pins and extend essentially in parallel to the longitudinal axis of the cylinder sleeve such that these make it possible for the journal to roll in the radial direction. Consequently, the roller elements are movably arranged in the radial direction of the journal such that the cylinder sleeve can move radially in relation to the housing. The journals are arranged essentially perpendicularly to the longitudinal axis of the cylinder housing and extend radially outward relative to the longitudinal axis of the cylinder sleeve. There is no fixed connection between the journals and the associated roller elements. Rather, the journals are supported tangentially on the housing via the particular roller element as a function of the torque applied at the cylinder housing. Therefore, contact between the journal and the particular roller element is not present at all times. Rather, in the case of a positive torque, the particular journal can come to rest against one of the two roller elements accommodated in the recess of the housing and, in the case of a torque acting counter thereto, can come to rest against the particular other roller element accommodated in the recess of the housing. In other words, a torque is introduced into the housing in the tangential direction regardless of the direction. A radial introduction of the torque into the housing is prevented in this way.

The roller elements make it possible that the particular journals coming to rest thereon as a function of the acting torque can roll or glide on the particular roller element when the cylinder sleeve moves radially. The journals are therefore arranged so as to be movable in the radial direction between the particular two roller elements such that there is a radial freedom of motion of the cylinder sleeve in relation to the housing. In other words, the journals do not rest radially against the housing. Due to the radial freedom of motion, which the movable roller elements of the cylinder sleeve offer, a radial excitation or a radial deformation of the cylinder sleeve can be nearly completely absorbed by the system. Due to the suitable arrangement of the journals on the cylinder housing, it is therefore achieved that the cylinder sleeve is always supported against the housing in the tangential direction. Consequently, radially acting forces of the cylinder sleeve are also directed tangentially into the housing.

Preferably, the journals are arranged uniformly distributed on an outer circumferential surface of the cylinder sleeve in order to implement a uniform distribution of force or transmission of force from the cylinder housing into the housing. In the case of four journals, these are therefore arranged at the quarter points on the outer circumference of the cylinder sleeve. In the case of three journals, these are distributed at the third points. Moreover, it is conceivable that the journals are arranged on an axial end face of the cylinder sleeve and extend radially outward.

Preferably, there is linear contact between the journals and the particular roller elements. Therefore, the journals also extend over at least a portion of the axial length of the cylinder sleeve. Preferably, the journals are as long as the axial length of the ring gear such that each journal has a particular contact surface, in any circumferential direction, for contacting with a particular roller element in order to be able to transmit a greater load in comparison to a point contact.

Further preferably, the journals are press-fit into recesses on the cylinder sleeve. The recesses are formed on the outer circumference of the cylinder sleeve and, further preferably, designed as axial grooves. This simplifies the manufacture of the cylinder sleeve, since the journals are only subsequently fixedly connected with the cylinder sleeve and press-fit into the particular groove. Alternatively, the journals are integrally bonded with the cylinder sleeve. In other words, the journals can also be welded to the cylinder sleeve.

Example aspects of the invention incorporate the technical teaching that the journals and the roller elements are arranged in the axial direction at least indirectly between a shoulder of the housing and a securing ring. As a result, there is an additional axial support of the cylinder sleeve on the housing. The securing ring can be designed, for example, as a snap ring and, moreover, can be partially accommodated in a circumferential groove on the inner circumference of the housing in order to direct the axial forces out of the cylinder sleeve into the housing and axially support the cylinder sleeve on the housing. The shoulder is preferably integrally connected with the housing or is integrally formed thereon.

A thrust washer is arranged between the securing ring and the journals in order to enlarge an axial contact surface. Therefore, the roller elements and the cylinder sleeve are axially tensioned between the shoulder of the housing and the thrust washer, which is axially secured by the securing ring.

Preferably, at least one portion of the roller elements have unequal outer diameters. It is conceivable that the outer diameter of only one roller element differs from the other roller elements, that the outer diameters of multiple roller elements differ from the outer diameters of the other roller elements, or that the outer diameters of all roller elements differ from one another. As a result, a compensation of manufacturing tolerances can be implemented and the positioning of the cylinder sleeve in the space can be adapted by suitably varying the roller diameter. In this way, in addition, a nearly play-free system is implemented.

According to one exemplary embodiment, the device is designed as a planetary transmission including a sun gear, a ring gear, and at least one planetary gear set having multiple planet gears, which are at least indirectly rotatably mounted on a planet carrier, wherein the journals extend radially outward starting from the ring gear, wherein each journal is arranged between two roller elements accommodated at the housing in order to support the ring gear on the housing in the tangential direction. In other words, the ring gear is to be understood as a cylinder sleeve within the meaning of the invention, wherein the previous comments presented with respect to the device also readily apply to the planetary transmission.

The ring gear under load undergoes an excitation of vibrations due to the meshing forces in the meshing of teeth between the ring gear and the planet gears intermeshed therewith. In addition to these direct excitations, eigenmodes of the ring gear, which are also referred to as resonances, are excited, which could result in an unusual sound of the overall system via the connection with the transmission housing. For the purpose of acoustic decoupling and, therefore, in order to improve the acoustic properties and to decouple vibrations, in particular, the radially aligned journals arranged between the roller elements are provided, which come to rest tangentially on the roller elements and are movable in the radial direction in relation to the housing. Consequently, the excitation of vibrations is completely decoupled from the housing, wherein, simultaneously, a comparatively stiff support of the torque, which arises due to the load, on the housing is possible via the journals and the roller elements. Therefore, a full functionality of the device and of the planetary transmission can be ensured also without a stationary fixation of the ring gear on the housing, wherein, however, the acoustic excitation is simultaneously completely shielded from the housing.

According to a further exemplary embodiment, the device is designed as an electric machine including a stator and a rotor, which is rotationally driveable in relation to the stator. The journals extend radially outward starting from the stator. Each journal is arranged between two roller elements accommodated on the housing in order to support the stator on the housing in the tangential direction. In other words, the stator is to be understood as a cylinder sleeve within the meaning of the invention, wherein the previous comments presented with respect to the device also readily apply to the electric machine.

During the rotary drive of the rotor arranged radially within the stator, the stator undergoes an excitation of vibrations. For the purpose of acoustic decoupling and, therefore, in order to improve the acoustic properties and to decouple vibrations, in particular, the radially aligned journals arranged between the roller elements are provided, which come to rest tangentially on the roller elements and are movable in the radial direction in relation to the housing. Consequently, the excitation of vibrations is completely decoupled from the housing, wherein, simultaneously, a comparatively rigid support of the stator on the housing is possible via the journals and the roller elements. Therefore, a full functionality of the device and of the electric machine can be ensured also without a stationary fixation of the stator on the housing, wherein, however, the acoustic excitation is simultaneously completely shielded from the housing.

### BRIEF DESCRIPTION OF THE DRAWINGS

Example embodiments of the invention are explained in greater detail in the following with reference to the drawings, wherein identical or similar elements are provided with the same reference characters, wherein

FIG. 1 shows a highly diagrammatic cross-sectional representation of a planetary transmission according to a first example embodiment,

FIG. 2 shows a highly diagrammatic longitudinal sectional representation of the planetary transmission according to FIG. 1,

FIG. 3 shows a highly diagrammatic cross-sectional representation of an electric machine according to a second example embodiment, and

FIG. 4 shows a highly diagrammatic longitudinal sectional representation of the electric machine according to FIG. 3.

### DETAILED DESCRIPTION

Reference will now be made to embodiments of the invention, one or more examples of which are shown in the drawings. Each embodiment is provided by way of explanation of the invention, and not as a limitation of the invention. For example, features illustrated or described as part of one embodiment can be combined with another embodiment to yield still another embodiment. It is intended that the present invention include these and other modifications and variations to the embodiments described herein.

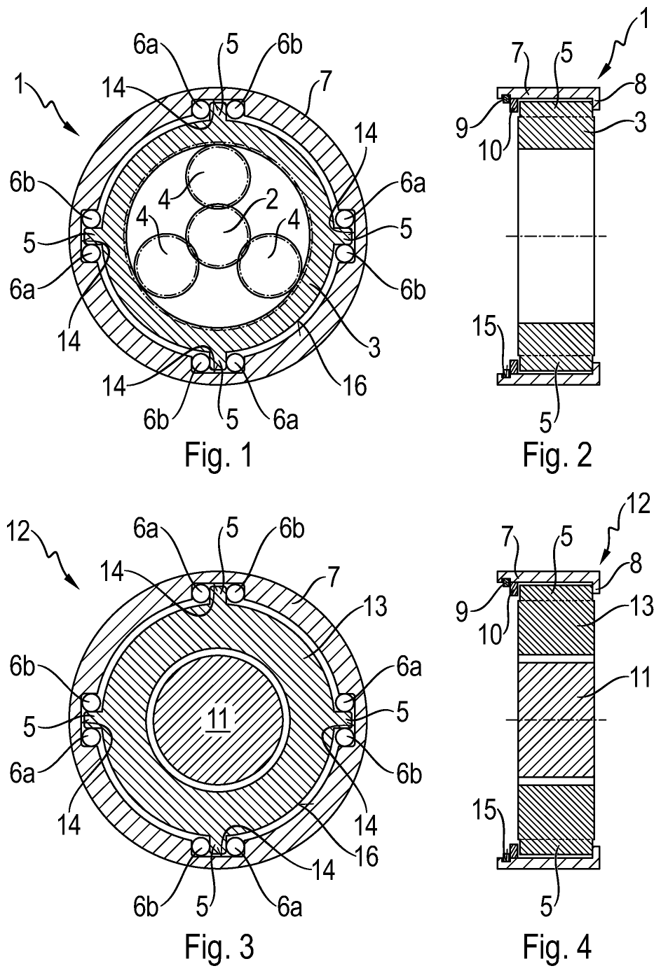

According to FIG. 1 and FIG. 2, a device designed as a planetary transmission 1 is shown in a highly diagrammatic way according to a first example embodiment. The exemplary planetary transmission 1 includes a sun gear 2, a cylinder sleeve-shaped ring gear 3 having an internal toothing, as well as a planetary gear set having multiple planet gears 4, which are rotatably mounted at least indirectly on a planet carrier (not represented here). In FIG. 2, a representation of the planet gears 4 and of the sun gear 2 is dispensed with for the sake of simplicity.

Four radially outward extending journals 5 are arranged uniformly distributed on an outer circumferential surface 16 of the ring gear 3. In the present case, two journals 5 are arranged essentially horizontally opposite each other on the ring gear 3 and two further journals 5 are arranged essentially vertically opposite each other on the ring gear 3, wherein the journals 5 extend over nearly the entire axial length of the ring gear 3, as is apparent in FIG. 2.

The journals 5 extend radially into a particular recess 14 on the housing 7 and are arranged between two particular roller elements 6a, 6b, which are arranged in the particular recess 14 and enable a tangential support of the ring gear 3 on the housing 7. Consequently, a torque acting on the ring gear 3 can be supported tangentially on the housing 7 via the journals 5 and, depending on the direction of the torque, via the particular roller element 6a, 6b. Simultaneously, each journal 5 is movable in the radial direction in relation to the housing 7, wherein the particular journal 5 can roll on the particular roller element 6a or 6b depending on the load and depending on the radial deflection of the ring gear 3. In other words, the journals 5 do not come to rest against the housing 7 in the radial direction. The journals 5 also rest against the roller elements 6a, 6b only as a function of an applied torque such that a non-permanent contacting between the journals 5 and the associated roller elements 6a, 6b and, consequently, an acoustic decoupling of the ring gear 3 from the housing 7 are implemented.

The roller elements 6a, 6b are designed to be cylindrical and their axial length corresponds essentially to the axial length of the journals 5. In particular, the roller elements 6a, 6b and the journals 5 are designed to be equally long. Consequently, there is linear contact between the journals 5 and the particular roller elements 6a, 6b. The roller elements 6a, 6b can therefore come to rest against the recess 14 of the housing 7 as well as against the journal 5.

Moreover, the journals 5 are press-fit into recesses—which is not shown in greater detail here—on the ring gear 3 such that a manufacture of the journals 5 and of the ring gear 3 can be carried out in a simplified and, therefore, more cost-effective manner. Alternatively, it is conceivable to integrally join the journals 5, for example, via welding, with the ring gear 3.

The journals 5 as well as the roller elements 6a, 6b are also axially tensioned in the housing 7 and, in fact, the journals 5 as well as the roller elements 6a, 6b come to rest, on the one hand, axially against a shoulder 8 of the housing 7, which is integrally connected to the housing 7, and, on the other hand, against a thrust washer 10. The thrust washer 10 is secured in its axial position by a securing ring 9 designed as a snap ring, which is accommodated in a circumferential groove 15 on the housing 7.

Roller elements 6a, 6b having different roller diameters can be utilized in order to compensate for manufacturing tolerances and adapt the positioning of the ring gear 3 in the space. Consequently, at least a portion of the roller elements 6a, 6b have unequal outer diameters such that, as a result, a play-free system is achieved.

As is highly diagrammatically represented in the second exemplary embodiment according to FIG. 3 and FIG. 4, the acoustic decoupling can also be provided in an electric machine 12. In other words, the device is designed as an electric machine 12 and includes a stator 13 and a partially represented rotor 11, which is rotationally drivable in relation to the stator 13. The only difference from the preceding embodiment is that the journals 5 are arranged on an outer circumferential surface 16 of the stator 13 and extend radially outward starting therefrom and, in so doing, are arranged between two roller elements 6a, 6b in order to tangentially support the stator 13. The mode of operation for the vibration decoupling takes place similarly to the comments presented with respect to the planetary transmission 1 according to FIG. 1 and FIG. 2.

Modifications and variations can be made to the embodiments illustrated or described herein without departing from the scope and spirit of the invention as set forth in the appended claims. In the claims, reference characters corresponding to elements recited in the detailed description and the drawings may be recited. Such reference characters are enclosed within parentheses and are provided as an aid for reference to example embodiments described in the detailed description and the drawings. Such reference characters are provided for convenience only and have no effect on the scope of the claims. In particular, such reference characters are not intended to limit the claims to the particular example embodiments described in the detailed description and the drawings.

Reference characters
1 planetary transmission
2 sun gear
3 ring gear
4 planet gear
5 journal
6a first roller element
6b second roller element
7 housing
8 shoulder
9 securing ring
10 thrust washer
11 rotor
12 electric machine
13 stator
14 recess on the housing
15 groove
16 outer circumferential surface

1-10. canceled

11. A device, comprising:
a housing (7);
a cylinder sleeve (3, 13) at least indirectly arranged at the housing (7), the cylinder sleeve (3, 13) comprising at least three radially outward extending journals (5), each journal (5) arranged between a respective pair of cylindrical roller elements (6a, 6b) accommodated at the housing (7) in order to support the cylinder sleeve (3, 13) on the housing (7) in a tangential direction, each journal (5) displaceable in a radial direction relative to the housing (7) by rolling on the respective pair of cylindrical roller elements (6a, 6b).

12. The device of claim 11, wherein the journals (5) are uniformly distributed on an outer circumferential surface of the cylinder sleeve (3, 13).

13. The device of claim 11, wherein there is linear contact between the journals (5) and the respective pair of cylindrical roller elements (6a, 6b).

14. The device of claim 11, wherein the journals (5) are press-fit into recesses on the cylinder sleeve (3, 13).

15. The device of claim 11, wherein the journals (5) are integrally bonded with the cylinder sleeve (3, 13).

16. The device of claim 11, wherein the journals (5) and the respective pair of cylindrical roller elements (6a, 6b) are arranged in an axial direction at least indirectly between a shoulder (8) of the housing (7) and a securing ring (9).

17. The device of claim 16, wherein a thrust washer (10) is arranged between the securing ring (9) and the journals (5).

18. The device of claim 11, wherein at least a portion of the roller elements (6a, 6b) have unequal diameters.

19. The device of claim 11, wherein:
the device is configured as a planetary transmission (1) that comprises a sun gear (2), a ring gear (3), and a plurality of planet gears (4);
the journals (5) extend radially outward starting from the ring gear (3); and
each journal (5) is arranged between the respective pair of cylindrical roller elements (6a, 6b) accommodated at the housing (7) in order to support the ring gear (3) on the housing (7) in the tangential direction.

20. The device of claim 11, wherein:
the device is configured as an electric machine (12) that comprises a stator (13) and a rotor (11), the rotor (11) rotationally drivable relative to the stator (13);
the journals (5) extend radially outward starting from the stator (13); and
each journal (5) is arranged between the respective pair of cylindrical roller elements (6a, 6b) accommodated at the housing (7) in order to support the stator (13) on the housing (7) in the tangential direction.
